(19) United States
(12) Patent Application Publication
(10) Pub. No.: US 2023/0037171 A1
(43) Pub. Date: Feb. 2, 2023

(54) STATEFUL MANAGEMENT OF STATE INFORMATION ACROSS EDGE GATEWAYS

(71) Applicant: VMWARE, INC., Palo Alto, CA (US)

(72) Inventors: JAYANT JAIN, Cupertino, CA (US); Xinhua Hong, Campbell, CA (US); Yong Wang, San Jose, CA (US); Abhishek Goliya, Pune (IN); Kai-Wei Fan, San Jose, CA (US)

(21) Appl. No.: 17/507,832

(22) Filed: Oct. 22, 2021

(30) Foreign Application Priority Data
Jul. 28, 2021 (IN) 202141034013

(51) Int. Cl. H04L 9/40; H04L 12/66; H04L 45/586; H04L 61/5007; H04L 45/02; H04L 45/28

(52) U.S. Cl. CPC H04L 63/0254; H04L 12/66; H04L 45/586; H04L 61/5007; H04L 45/02; H04L 45/28; H04L 63/0236

(57) ABSTRACT

Described herein are systems, methods, and software to manage state information and failover between edge gateways (edges) in a computing environment. In one example, a first edge receives state information associated with one or more logical routers on a second edge. The first edge further identifies a failure in association with the second edge and, in response to the failure, make one or more logical routers available in the first edge to operate in place of the one or more logical routers in the second edge based on the state information.

### RELATED APPLICATION

Benefit is claimed under 35 U.S.C. 119(a)-(d) to Foreign Application Serial No. 202141034013 filed in India entitled “STATEFUL MANAGEMENT OF STATE INFORMATION ACROSS EDGE GATEWAYS”, on Jul. 28, 2021, by VMware, Inc., which is herein incorporated in its entirety by reference for all purposes.

### BACKGROUND

In computing environments, edge gateways or edges are used to provide network connectivity for host computing systems. These host computing systems may execute virtual machines, containers, or some other virtualized endpoint. The edge gateways may be used to provide various operations on the ingress and egress packets to the various hosts, including firewall operations, filtering, encryption/decryption, or some other operation with respect to the packets. For example, a packet may be received at an edge from an external network, processed by the edge, and forwarded to a destination host.

However, while edges may provide networking operations to connect hosts and the virtual computing elements to an external network, difficulties can arise as the number of edges is increased in a computing environment. In some implementations, each of the edges may provide operations on a different set of internet protocol (IP) addresses, requiring packets to be exchanged between the edges for processing. Additionally, failover issues can arise when an edge fails in the computing environment, terminating connections or limiting the number of available edges in the computing environment.

### SUMMARY

The technology described herein manages state information between edge gateways in a computing environment. In one implementation, a first edge gateway has a first logical router in an active state and a second logical router in a standby state and receives state information associated with a third logical router in an active state from a second edge gateway. The first edge gateway further identifies a failure in association with the second edge gateway and changes the second logical router to an active state to operate in place of the third logical router based on the state information. The first edge gateway then maintains second state information for the first logical router and third state information for the second logical router.

### BRIEF DESCRIPTION OF THE DRAWINGS

FIG. 1 illustrates a computing environment to manage state information and failover between edge gateways according to an implementation.

FIG. 2 illustrates a method of operating an edge gateway to manage state information and failover from another edge gateway according to an implementation.

FIGS. 3A-3C illustrate an operational scenario of managing state information and failover between edge gateways according to an implementation.

FIG. 4 illustrates computing environment to manage state information and failover between edge gateways according to an implementation.

FIG. 5 illustrates an operational scenario of routing packets in a computing environment according to an implementation.

FIG. 6 illustrates an edge computing system to manage state information and failover between edge gateways according to an implementation.

### DETAILED DESCRIPTION

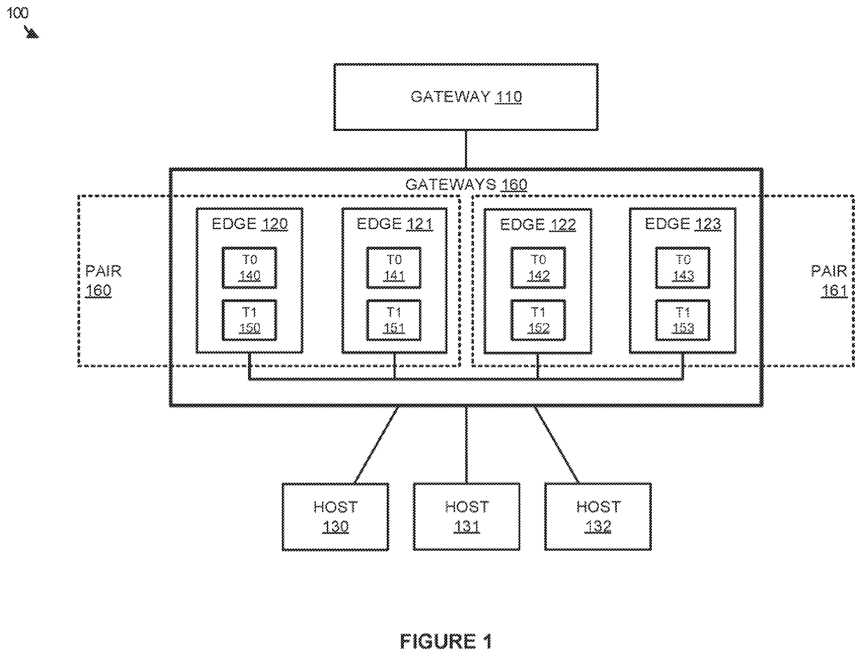

FIG. 1 illustrates a computing environment 100 to manage state information and failover between edge gateways according to an implementation. Computing environment 100 includes gateway 110, gateways 160, and host 130-132. Gateways 160 includes edge gateways (edges) 120-123, wherein edges 120-121 are representative of a first status pair 160 and edges 122-123 are representative of a second status pair 161. Edges 120-123 include corresponding tier-0 (T0) logical routers 140-143 and tier-1 (T1) logical routers 150-153.

In computing environments, hosts 130-132 are deployed to provide a platform for virtual computing elements, such as virtual machines, containers, or some other virtualized endpoint. To provide connectivity for the virtual computing elements, logical and physical networking may be used to provide firewalls, switching, routing, encapsulation, and other operations with respect to the ingress and egress packets for the virtual machines. Here, to provide high availability, each of the hosts is connected to edges 120-123, permitting packets to be sent or received from the host using any of the available edges. Similarly, gateway 110, which may comprise another switch or router, is communicatively coupled to edges 120-123, permitting packets to be routed to hosts 130-132 using various routes. In selecting the routes between gateway 110 and hosts 130-132, gateway 110 and hosts 130-132 may perform equal-cost multi-path routing (ECMP), round-robin, or some other routing operation to select an edge from edges 120-123. The selection may be based on hashing information in a packet, randomly selecting an edge from edges 120-123, or performing some other operation to select an edge from edges 120-123.

Edges 120-123 include T0 logical routers and T1 logical routers. T0 logical routers provide an on and off gateway service between the logical and the physical network. The T0 logical routers may have downlink ports that are coupled to the T1 logical routers and uplink ports that are coupled to external networks. The T1 logical routers are each coupled to a T0 logical router using uplink ports and are coupled to logical switches associated on hosts 130-132 on the downlink ports. The logical routers may provide firewalls, address translation, encryption and decryption, or some other operation.

In some implementations, each of edges 120-123 may include services to process packets corresponding to different addressing attributes. Accordingly, even if a packet is provided from a host using ECMP, the edge may perform a second operation on the packet to determine which of the edges should be used to process the packet. For example, host 130 may communicate a packet to edge 120. In response to receiving the packet, the host may select a second edge from edges 121-123 to process the packet and forward the packet to the selected host. This selection may be performed based on addressing of the packet (including interior addressing of the packet if the received packet comprises an encapsulation packet), such as hashing IP addressing in the packet, or some other information in the packet received from the host. After being processed by the selected edge, the edge may forward the packet toward gateway 110.

In some implementations, edges may be configured to provide high availability, wherein a failure by an edge may not terminate connections over the edge. An edge may fail because of hardware failure, a software issue, a restart of the physical computer, or due to some other circumstance. Here, edges 120-121 are part of pair 160, while edges 122-123 are part of pair 161. Each pair is configured to share state information about the current configurations associated with the T0 and T1 router. The state information may include addressing information, firewall state information, Internet Protocol Security (IPsec) information, or some other information about the addressing or connections of the edges in the corresponding pair. When a failure occurs, standby versions (or routers in a “standby state”) of the T0 and T1 logical routers may be made active in the opposite edge, such that connections can be maintained at the failed edge. For example, if a failure occurred at edge 121, then a replacement T0 and T1 may be made active (placed in an “active state”) on edge 120 based on the state information shared from edge 121 prior to the failure. The state information may include IPsec status information, flow table update information, active IP address information, firewall information, or some other information. When in an active state, a logical router may be capable of receiving data packets by advertising addressing to other gateways and/or hosts, whereas in a standby state, the logical router may not receive data packets or advertise itself to gateways and/or hosts.

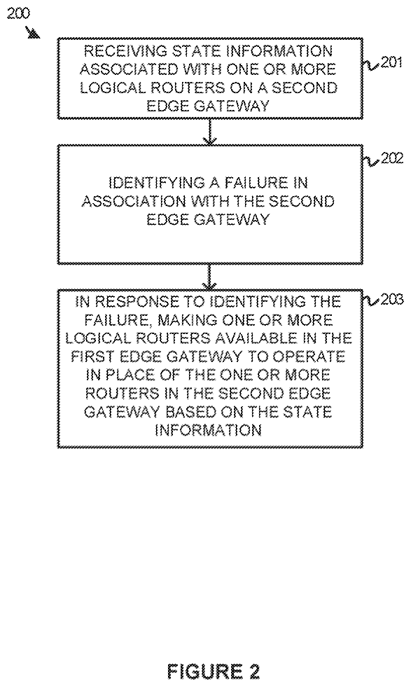

FIG. 2 illustrates a method 200 of operating an edge gateway to manage state information and failover from another edge gateway according to an implementation. The steps of method 200 are referenced parenthetically in the paragraphs that follow with reference to systems and elements of computing environment 100 of FIG. 1.

As depicted, method 200 includes receiving (201) state information associated with one or more logical routers on a second edge gateway. For example, edge 120-121 may share state information about IP addresses for the logical routers, IPsec information for connections associated with the edge, firewall state information, or some other state information associated with the edge. The state information may be provided periodically, when a change occurs to the state information, or at some other interval.

As the state information is exchanged between the edges, method 200 further identifies (202) a failure in association with the second edge gateway. In some implementations, the edges that are part of a pair may exchange health communications to determine when the other edge has failed. For example, edge 120 may communicate health check packets with edge 121 to determine when a failure has occurred with edge 121. The failure may include a loss of power, a software failure, a restart of the physical computing system, or some other failure. In response to identifying the failure, method 200 further makes (203) one or more logical routers available (places the one or more logical routers in an active state from a standby state) in the first edge gateway to operate in place of the one or more logical routers in the second edge gateway based on the state information.

In some implementations, edges in a pair may maintain standby logical routers (logical routers in a standby state) that can be used during the failure of the other edge. The standby logical routers may be provided with state information including addressing, IPsec state information for connections, and other information to provide the same functionality as the unavailable logical routers. The exchange of state information may be performed using a controller on each edge of edges 120-123, wherein the controller may be responsible for gathering and distributing the required state information via a control plane between the corresponding pair. As an example, edge 121 may fail due to power loss. In response to identifying the failure, in some examples using health check packets, edge 120 may initiate operations to make standby logical routers at edge 120 act in place of the unavailable logical routers from edge 121. This may include allocating the addressing associated with logical routers on the failed node to the standby logical routers on edge 120. This allocation may permit the standby routers to become active by advertising the addresses to other connected gateways and hosts to communicate to edge 120 in place of edge 121. The advertising of the addresses may use Gratuitous Address Resolution Protocol (GARP), border gateway protocol (BGP), or some other addressing protocol. Thus, during a failover of edge 121, the IP address originally used for T0 141 may be advertised by a standby T0 logical router that is placed in an active state on edge 120.

After making the one or more standby logical routers act in place of the logical routers from the failed edge, the edge with the standby logical routers may monitor for when the failed edge is active again. Referring again to the failure of edge 121, edge 120 may continue to perform health monitoring on edge 121 to determine availability of the edge. Once it is identified that edge 121 is available, edge 120 may communicate state information in accordance with the standby T0 and T1 logical routers operating on edge 120. After communicating the state information to edge 121, edge 121 may initiate a process to make the logical routers active on edge 121 in place of the standby logical routers on edge 120.

In some implementations, edge 121 may allocate the addressing information to the logical routers (IP addresses) and notify edge 120 that the standby logical routers can be returned to a standby state. Advantageously, this may permit traffic to be routed through the logical routers on edge 121 via addressing advertisement in place of the standby logical routers on edge 120. Additionally, edge 121 may provide continuity using the IPsec information and firewall information provided by edge 120 when edge 121 became available.

In some implementations, when the state information is provided from edge 121 about logical routers 141 and 151, the state information is maintained in separate data structures (i.e., flow tables, firewall status data structures, and the like). In other implementations, the state information is tagged, such that the state information associated with each logical router is not introduced to the state information of another logical router. For example, when the state information is provided for T0 logical router 141 to edge 120, the state information is maintained separately from the state information for T0 logical router 140. Thus, when a failure occurs in association with edge 121, edge 120 continues to maintain state information for the standby T0 logical router placed in an active state on edge 120 and keeps the state information separate from the state information associated with T0 logical router 140. When edge 121 becomes available again, the maintained state information for the standby T0 logical router is provided to edge 121, permitting edge 121 to place T0 logical router 141 in an active state to replace the standby T0 logical router on edge 120.

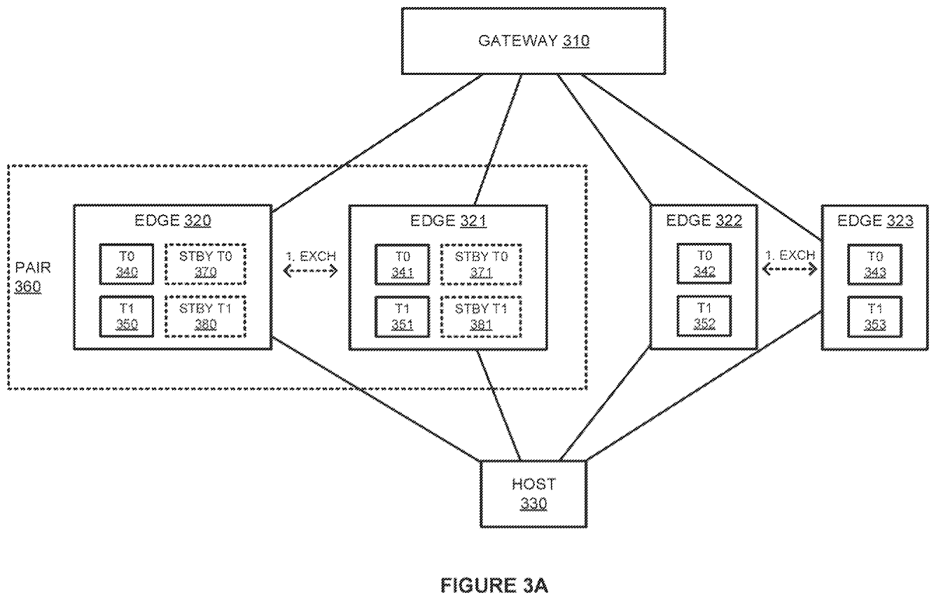

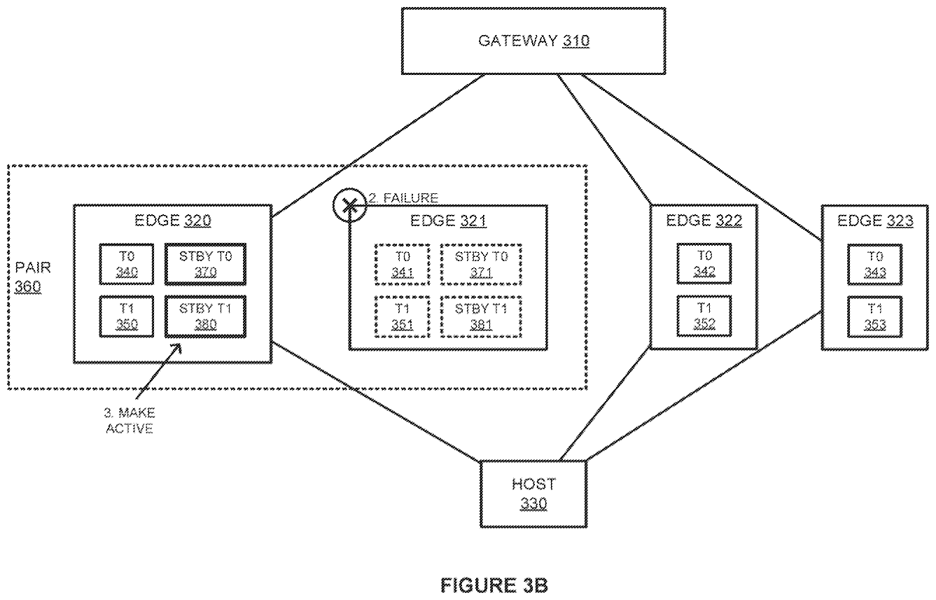

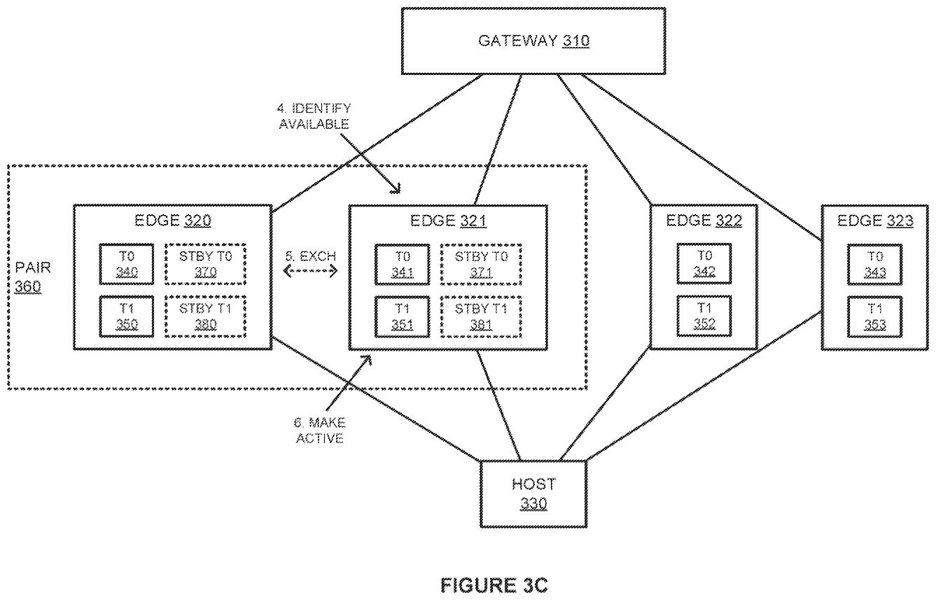

FIGS. 3A-3C illustrate an operational scenario of managing state information and failover between edge gateways according to an implementation. FIGS. 3A-3C include gateway 310, edges 320-323, and host 330. Edges 320-321 represent pair 360 that is used to provide failover and high availability for logical routers. Edges 320-323 further include T0 logical routers 340-343 and T1 logical routers 350-353. Edges 320-321 further include standby T0 logical routers 370-371 and standby T1 logical routers 380-381. Although not demonstrated in the example of FIGS. 3A-3C, edges 322-323 may also represent an edge pair and further include standby routers to provide failover and high availability.

Referring first to FIG. 3A, FIG. 3A routes packets to and from host 330 over edges 320-323 to gateway 310. In some implementations, gateway 310 may use a form of ECMP to select an edge from edges 320-323 and forward the packet to the corresponding edge. Similarly, host 330 may perform ECMP to select an edge from edges 320-323 for egress packets from the host. Once the packet is received by an edge of edges 320-323, the receiving edge may perform a hash to determine which of edges 320-323 should process the packet using the T0 and T1 routers. The hash may be on source or destination addressing for the packet or some other information in the packet. As an example, when gateway 310 communicates a packet to edge 320, edge 320 may identify which edge of edges 320-323 should be selected to process the packet and, if required, forward the packet to the selected edge, or process the packet locally. In some examples, the selection may be based on a hash of the source IP address included in the packet. Once processed and permitted by the firewall, the packet may be forwarded to the destination host. Similar operations may also be performed by the edges when a packet is received from the host, wherein addressing in the packet may be hashed to select the edge of edges 320-323 to process the packet. In processing the packets at each of the edges, the edges may perform firewall services, encryption services, encapsulation services, or some other service. The processing at the edges may also include forwarding the packet toward a destination computing element.

In the present example, edges 320-321 include active T0 logical routers 340-341 (routers in an “active state”) and active T1 logical routers 350-351 and include standby T0 logical routers 370-371 (routers in a “standby state”) and standby T1 logical routers 380-381. Logical routers 370 and 380 are representative of logical routers in a standby state for logical routers 341 and 351, respectively. Logical routers 371 and 381 are representative of logical routers in a standby state for logical routers 340 and 350. In operation, edges 320 may share or exchange, at step 1, state information associated with the active logical routers on each of the edges. The state information may include addressing information associated with the logical routers, IPsec tunneling information associated with each of the routers, firewall state information, or some other information that permits the standby logical routers to act in place of the operating routers.

Turning to FIG. 3B, edge 320 may identify, at step 2, a failure associated with edge 321. The failure may be caused by a hardware issue, a software issue, an update, a power loss, or some other reason. In some implementations, edge 320 may exchange health check communications to determine the availability with edge 321. If the health check communications indicate that edge 321 is available, the standby logical routers will remain inactive. However, if the health check communications indicate that edge 321 has failed, then edge 340 may make active standby logical routers 370 and 380 to replace the logical routers from the failed edge at step 3. In making logical routers 370 and 380 active, the logical routers may advertise addressing information (at least one IP address) provided from edge 321 to act as logical routers in place of logical routers 341 and 351. Logical routers 370 may further use the exchanged IPsec information and firewall state information to maintain the operations initially provided by logical routers 341 and 351. By advertising the addresses associated with T0 logical router 341 and/or T1 logical router 351, standby logical routers 370-380 may receive packets in place of the unavailable logical routers on edge 321.

In some implementations, edge 320 may maintain separate data structures or tables for the state information associated with each logical router. For example, the state information may be maintained separately or tagged separately in the same data structure to differentiate between the state of T0 logical router 340 and standby T0 logical router 370. The data structures may include flow tables or some other data structure that separates the state information for each of the logical routers. The separation of state information is maintained while the standby logical routers are in an active state, such that the state information associated with the standby logical routers can be provided to edge 121 when edge 121 returns to being available.

Turning to FIG. 3C, after the standby logical routers are made active in edge 320, edge 320 may monitor, at step 4, the health of edge 321 to determine when it becomes available. In some implementations, the determination may be made using health check communications to determine when edge 321 indicates availability back to edge 320. In response to identifying that edge 321 is available, edge 320 may exchange state information associated with the current status for the standby logical routers 370 and 380 to edge 321. The current state information may include any required addressing information, IPsec information, firewall state information, or other information that permits logical routers 341 and 351 on edge 321 to be active. Once all the state information is provided to edge 321, edge 321 may make active logical routers 341 and 351 to replace standby logical routers 370 and 380 of edge 320. In making the logical routers active, standby logical routers 370 and 380 may no longer advertise as being active (advertise IP addresses), while logical routers 341 and 351 may advertise or broadcast as being active using the IP addresses surrendered by the standby logical routers. Edge 321 may then maintain the state information associated with active state logical routers 141 and 351 and may further receive state information associated with standby logical routers 371 and 381 from edge 320.

Once edge 321 is active, the edges may continue to exchange health communications to determine if another failure occurs. Although demonstrated in the example of FIGS. 3A-3C using edges 320-321, edges 322-323 may provide an additional pair that can exchange and facilitate a failover condition. Further, while not described in the previous example, if both edges of a pair fail, the logical routers will become unavailable, losing the IPsec sessions and the status of the firewall. Moreover, while described in the examples above as using active/active edges, wherein both edges are active executing one or more logical routers and capable of supporting failover from the other edge, similar operations may be performed in an active/standby configuration. For example, edge 121 may be a standby edge for edge 120, wherein edge 120 may provide state information to edge 121 related to the state of the logical routers on edge 120. In response to identifying a failure with edge 120, edge 121 may become active using the IP addressing information, IPsec information, firewall state information, or any other information provided as part of the state information.

Although demonstrated in the examples of FIG. 1 and FIGS. 3A-3C with edges including both a T0 logical router and a T1 logical router, some examples of edges may only include a single logical router. For example, edges 120-121 may include both T0 and T1 logical routers, while edges 122-123 may include only a T1 logical router that can communicate with edges 120-121 to provide the required T0 functionality. Edges 122-123 in this example may also provide high availability by exchanging state information and providing failover operations when it is determined that an edge fails.

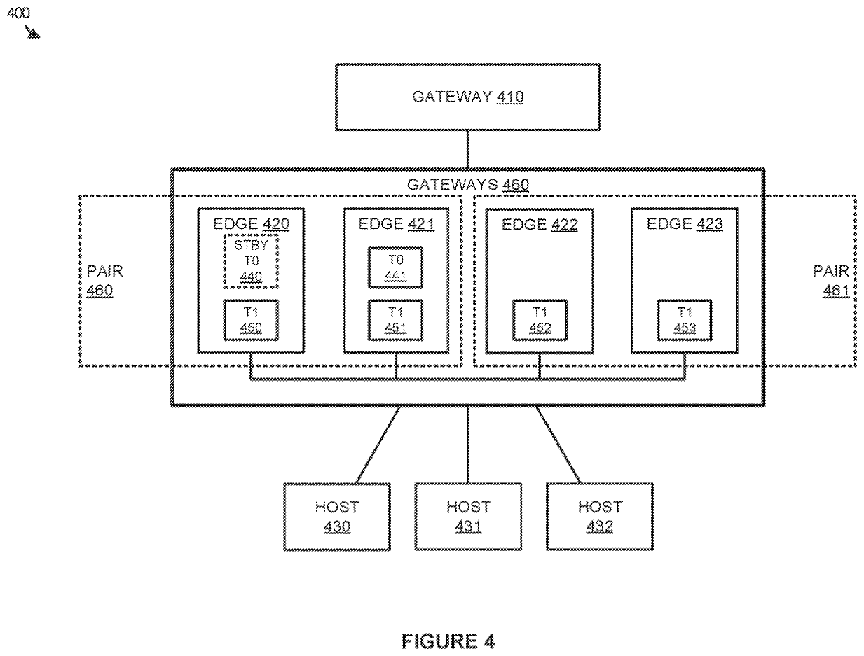

FIG. 4 illustrates computing environment 400 to manage state information and failover between edge gateways according to an implementation. Computing environment 400 includes gateway 410, gateways 460, and hosts 430-432. Gateways 460 includes edge gateways (edges) 420-423, wherein edges 420-421 are representative of a first status pair 460 and edges 422-423 are representative of a second status pair 461. Edges 420-421 include corresponding T0 logical routers 440-441 and T1 logical routers 450-451. Edges 422-423 include corresponding T1 logical routers 452-453.

In computing environment 400, edge 421 provides an active T0 logical router 441 that is supported by a standby T0 logical router 440 on edge 420. T1 logical routers 450-453 are active in computing environment 100, where each of the T1 logical router is associated with a standby logical router available on the other edge in the pair. For example, T1 logical router 450 may have a corresponding standby logical router on edge 421, while T1 logical router 451 may have a standby logical router on edge 420.

To implement the high availability for the logical routers on edges 420-423, edges 420-421 may exchange state information associated with the state the logical routers on edges 420-421, while edges 422-423 may exchange state information associated with the state of the logical routers on edges 422-423. For pair 460, the exchange of information from edge 420 to edge 421 may include state information for T1 logical router 450, while the exchange of information from edge 421 to edge 420 may include state information associated with logical routers 441 and 451. For pair 461, the exchange of information from edge 422 to edge 423 may include state information associated with T1 logical router 452, while the exchange of information from edge 423 to edge 422 may include state information associated with T1 logical router 453. The state information may include IP addressing information, IPsec session information, firewall state information, or some other information related to the active state of the logical router.

As the state information is exchanged, edges 420-423 may identify when the other edge in the pair suffers a failure. For example, edge 420 may use health check communications to determine when a failure occurs in association with edge 421. The failure may comprise a hardware failure, power failure, software failure, or some other failure in association with edge 421. The failure may be identified when edge 421 proactively communicates about the failure or may be identified when there is no response from edge 421 to a health check communication. When a failure is identified, edge 420 may make standby T0 logical router 440 active to act in place of T0 logical router 441. Additionally, a standby T1 logical router may be initiated or made active on edge 420 to act in place of T1 logical router 451. In making the logical routers active, the logical routers may assume the IP addresses associated with the failed logical routers, such that packets using the addresses may be directed to the standby logical routers. Further, using the state information, including the IPsec information and firewall information, the standby routers may be capable of providing one or more replacement logical routers for the failed edge.

In addition to monitoring when an edge fails, the edges may further determine when edge returns to being available. Returning to the example of edge 421 failing, edge 420 may continue to monitor health communications with edge 421 to determine when edge 421 can execute the required logical routers. When a notification is received that edge 421 is available, edge 420 may communicate state information associated with the executing standby logical routers to edge 421. The state information may include addressing information, IPsec information, firewall state information or some other information related to the current state of standby T0 logical router 440 and the standby logical router for T1 logical router 451. Once the state information is provided, logical routers 441 and 451 may be made active on edge 421. In making the logical routers active, logical routers 441 and 451 may assume the addressing from the standby logical routers, while the standby logical routers stop using the addressing.

Like the operations described above with respect to edges 420-421, edges 422-423 may exchange state information associated with T1 logical routers 452-453. Further, each of edges 422-423 may monitor for a failure of the other edge in pair 461 and, when a failure is identified, make a standby logical router active in place of the logical router on the failed edge. For example, edge 423 may fail due to a power outage. In response to detecting the failure, edge 422 may make a standby logical router active in place of T1 logical router 453. In making the standby logical router active, edge 422 may allocate IP addressing to the standby logical router that was allocated to T1 logical router 453, may use the IPsec and firewall state information from edge 423, or may use some other state information exchanged between the edges. Additionally, edge 422 may monitor for when edge 423 becomes available again and may provide current state information associated with the standby logical router to edge 423, permitting edge 423 to make active T1 logical router 453.

Although demonstrated in the previous examples using a single failure of an edge, when two of the edges fail in a pair, state information will not be maintained. Further, in examples where logical routers are in an active state on both edges, the computing resources of the edge should not exceed fifty percent prior to failover, as failover would require the additional resources of the remaining edge in the pair.

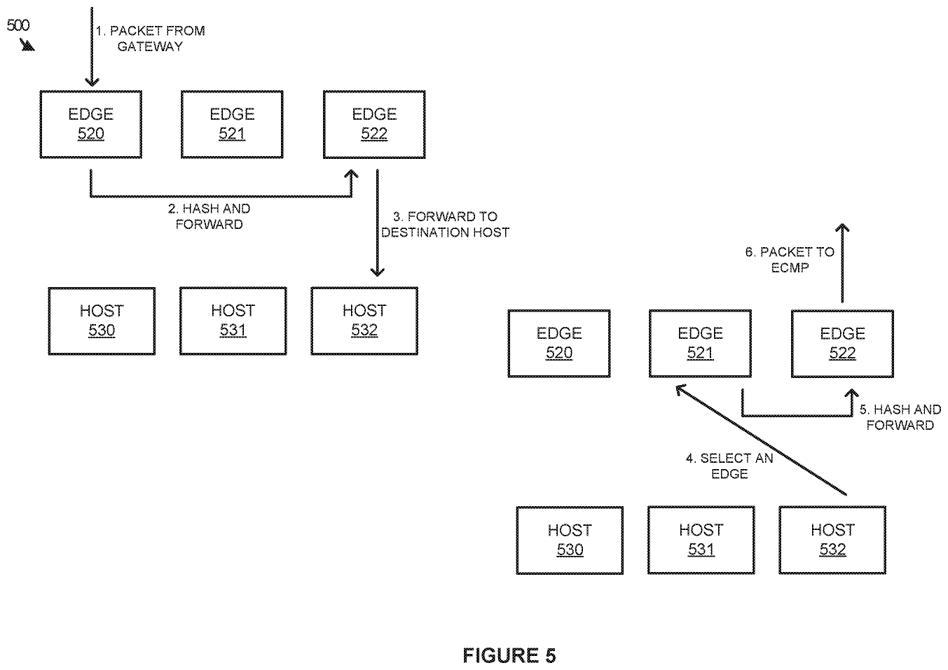

FIG. 5 illustrates an operational scenario 500 of routing packets in a computing environment according to an implementation. Operational scenario 500 includes edges 520-522 and hosts 530-532.

When a packet is received at an edge from an external gateway, the edge may execute a hash on addressing information for the packet to select and forward the packet for processing by the logical router on the selected edge. Here, a packet is received by edge 520 at step 1. In response to receiving the packet, edge 520 may perform a hash, at step 2, on the addressing on the packet to select an edge from edges 520-522. Advantageously, independently of the upstream gateway selection process, the edges may select the appropriate edge for processing the packet. In some implementations, the hash may be performed on a source IP address in the packet. Once a hash value is determined, edge 520 may determine an edge that corresponds to the value and forward the packet to the edge, which in the example comprises edge 522. Once forwarded, edge 522 may process the packet and forward the packet to a destination host 532. The processing may include decapsulation, firewall services, IPsec services, or some other services in association with the packet.

After receiving the packet, a computing element on host 532 (virtual machine, container, and the like) may generate a return packet. Host 532 may select an edge using ECMP, random selection, or by some other mechanism and forward the packet to the selected edge, at step 4. In response to receiving the packet edge 521 may hash addressing information in the packet, such as the destination IP address in some examples, and forward, at step 5, the packet to edge 522 to provide continuity in processing packets for the connection. Once processed by edge 522 the packet may be forwarded to an upstream gateway at step 6. Although demonstrated with a communication being initiated from a remote source, similar hashing operations may be provided when a connection is initiated from computing node on a host.

In some implementations, two edges in a computing environment may be configured for high availability. For example, edges 521-522 may comprise a high availability pair for logical routers located on edges 521-522. To provide the high availability, edges 521-522 may exchange state information associated with the logical routers, which may include addressing information, IPsec session information, firewall state information, or some other information. As the information is exchanged, edges 521-522 may monitor and determine when a failure occurs in association with the peer edge. For example, edge 521 may identify that edge 522 has failed. In response to the determination, edge 521 may make one or more logical routers active on edge 521 to act in place of the logical routers for edge 522. In making the logical routers active on edge 521, the logical routers may assume the addressing attributes associated with the logical routers from edge 522 and advertise the addresses to other routing elements. Additionally, the logical routers made active may also assume any IPsec information or firewall state information provided from edge 522. Advantageously, even when edge 522 is unavailable, packets may still be communicated to logical routers located on edge 521 that act in place of the logical routers from edge 522.

In some examples, edge 521 may further monitor for when edge 522 indicates being available again. Edge 521 may continue to exchange health monitoring communications and determine when the edge is available. Once available, edge 521 may provide current state information associated with the logical routers to edge 522, permitting edge 522 to make active the local logical routers to replace the standby logical routers from edge 521. In making the logical routers on edge 522, edge 522 may assume the IP addresses used by the logical routers of edge 521, while edge 522 may deallocate the IP addresses from the logical routers. Thus, packets will be directed to edge 522 in place of edge 521.

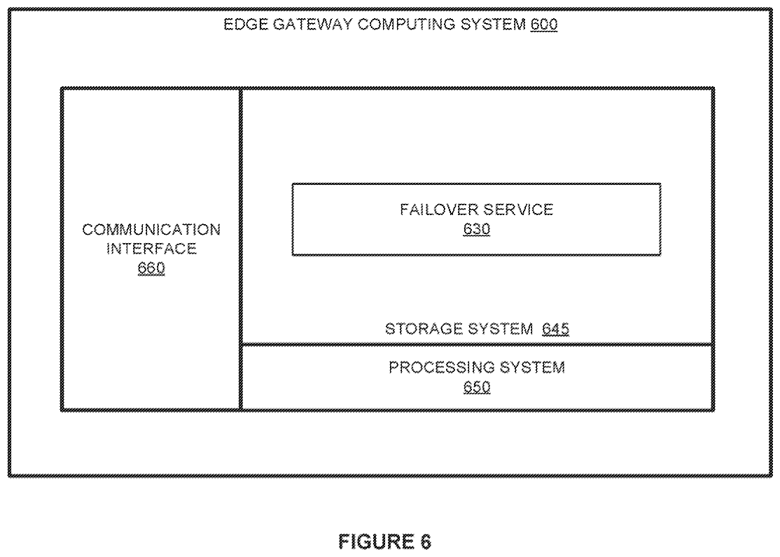

FIG. 6 illustrates an edge computing system 600 to manage state information and failover between edge gateways according to an implementation. Computing system 600 is representative of any computing system or systems with which the various operational architectures, processes, scenarios, and sequences disclosed herein for an edge gateway can be implemented. Computing system 600 is an example of edges 120-123 of FIG. 1, although other examples may exist. Computing system 600 includes storage system 645, processing system 650, and communication interface 660. Processing system 650 is operatively linked to communication interface 660 and storage system 645. Communication interface 660 may be communicatively linked to storage system 645 in some implementations. Computing system 600 may further include other components such as a battery and enclosure that are not shown for clarity.

Communication interface 660 comprises components that communicate over communication links, such as network cards, ports, radio frequency (RF), processing circuitry and software, or some other communication devices. Communication interface 660 may be configured to communicate over metallic, wireless, or optical links. Communication interface 660 may be configured to use Time Division Multiplex (TDM), Internet Protocol (IP), Ethernet, optical networking, wireless protocols, communication signaling, or some other communication format—including combinations thereof. Communication interface 660 is configured to communicate with other edges, host computing systems, and one or more other gateways. In some implementations, communication interface 660 may communicate with one or more other edges to exchange packets for processing and to exchange state information for the has

Processing system 650 comprises microprocessor and other circuitry that retrieves and executes operating software from storage system 645. Storage system 645 may include volatile and nonvolatile, removable and non-removable media implemented in any method or technology for storage of information, such as computer readable instructions, data structures, program modules, or other data. Storage system 645 may be implemented as a single storage device but may also be implemented across multiple storage devices or sub-systems. Storage system 645 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no case is the storage media a propagated signal.

Processing system 650 is typically mounted on a circuit board that may also hold the storage system. The operating software of storage system 645 comprises computer programs, firmware, or some other form of machine-readable program instructions. The operating software of storage system 645 comprises failover service 630 capable of providing at least the method described in FIG. 2. The operating software on storage system 645 may further include an operating system, utilities, drivers, network interfaces, applications, or some other type of software. When read and executed by processing system 650 the operating software on storage system 645 directs computing system 600 to operate as described herein.

In at least one implementation, failover service 630 directs processing system 650 to receive state information associated with one or more logical routers on a second edge gateway. The state information may comprise IP addressing information allocated to the logical routers, IPsec state information for connections over the one or more logical routers, state information associated with the firewalls implemented in the one or more logical routers, or some other state information associated with the logical routers. Failover service 630 further directs processing system 650 to identify a failure in association with the second edge gateway, wherein the failure may comprise a hardware, power, software, or some other failure. In response to identifying the failure, failover service 630 directs processing system 650 to make one or more logical routers available in the first edge gateway to operate in place of the one or more logical routers in the second edge gateway based on the state information. In some implementations, in making the logical routers active on computing system 600, failover service 630 may allocate or assume the IP addresses from the logical routers on the other edge and use the IPsec information and firewall information to provide continuity with the communications. Accordingly, while an IPsec session may be initiated using a first edge, the IPsec session may be continued using the second edge.

After computing system 600 makes the logical routers available, failover service 630 may direct processing system 650 to monitor for when the paired edge becomes available and can return to the logical routers to the paired edge. In returning the logical routers to the paired edge, failover service 630 may provide state information to the other edge. Once provided, the other edge may make the one or more logical routers active, while edge computing system 600 may make the local one or more routers inactive. This may include deallocating the IP addresses to the one or more logical routers on computing system 600, stopping execution of one or more processes related to the logical routers on computing system 600, or providing some other operation to permit the logical routers to operate on another edge.

In some implementations, the state information for an active logical router may be stored or identified separately on edge gateway computing system 600 from a standby logical router. For example, while a first logical router on computing system 600 may be in an active state and state information may be passed to a second gateway. Additionally, state information for an active logical router on the second edge may be provided to computing system 600 and may be maintained separate from the state information of the active logical router. As a result, if the standby logical router is required to start on computing system 600 for a failure of the second edge, the state information associated with the standby logical router will be maintained separate of the state information for the other logical router implemented on computing system 600. The separate state information may be maintained in separate data structures, may be maintained using separate tags, or may be maintained in some other manner.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method comprising:
in a first edge gateway having a first logical router in an active state and a second logical router in a standby state, receiving state information associated with a third logical router in an active state from a second edge gateway;
in the first edge gateway, identifying a failure in association with the second edge gateway;
in the first edge gateway and in response to the failure, changing the second logical router to an active state to operate in place of the third logical router based on the state information; and
in the first edge gateway, maintaining second state information for the first logical router and third state information for the second logical router.

2. The method of claim 1, wherein the state information comprises at least firewall state information.

3. The method of claim 1, wherein the state information comprises IPsec state information.

4. The method of claim 1, wherein changing the second logical router to an active state to operate in place of the third logical router based on the state information comprises advertising, for the second logical router, at least one IP address previously used to address the third logical router.

5. The method of claim 1 further comprising:
in the first edge gateway, identifying that the second edge gateway is available;
in the first edge gateway and in response to identifying that the second edge gateway is available, communicating the third state information to the second edge gateway;
in the second edge gateway, receiving the third state information;
in response to receiving the third state information and in the second edge gateway, setting the third logical router to an active state to operate in place of the second logical router based on the third state information.

6. The method of claim 5 further comprising, in response to communicating the third state information to the second edge gateway, setting the second logical router to a standby state.

7. The method of claim 1, wherein identifying the failure in association with the second edge gateway comprises identifying that the second edge gateway is unresponsive to a health check message.

8. The method of claim 1, wherein the first logical router, the second logical router, and the third logical router comprise tier-0 router or tier-1 logical routers.

9. The method of claim 1 further comprising:
in the first edge gateway, communicating the second state information associated with the first logical router to the second edge gateway, wherein the second edge gateway includes a fourth logical router in a standby state for the first logical router.

10. A computing apparatus comprising:
a storage system;
a processing system operatively coupled to the storage system; and
program instructions stored on the storage system that, when executed by the processing system, direct the computing apparatus to:
in a first edge gateway having a first logical router in an active state and a second logical router in a standby state, receive state information associated with a third logical router in an active state from a second edge gateway;
in the first edge gateway, identify a failure in association with the second edge gateway;
in the first edge gateway and in response to the failure, change the second logical router to an active state to operate in place of the third logical router based on the state information; and
in the first edge gateway, maintain second state information for the first logical router and third state information for the second logical router.

11. The computing apparatus of claim 10, wherein the state information comprises at least firewall state information.

12. The computing apparatus of claim 10, wherein the state information comprises IPsec state information.

13. The computing apparatus of claim 10, wherein changing the second logical router to an active state to operate in place of the third logical router based on the state information comprises advertising, for the second logical router, at least one IP address previously used to address the third logical router.

14. The computing apparatus of claim 10, wherein identifying the failure in association with the second edge gateway comprises identifying that the second edge gateway is unresponsive to a health check message.

15. The computing apparatus of claim 10, wherein the first logical router, the second logical router, and the third logical router comprise tier-0 router or tier-1 logical routers.

16. The computing apparatus of claim 10, wherein the program instructions further direct the computing apparatus to:
in the first edge gateway, identify that the second edge gateway is available;
in the first edge gateway and in response to identifying that the second edge gateway is available, communicate the third state information to the second edge gateway;
in the second edge gateway, receive the third state information;
in response to receiving the third state information and in the second edge gateway, set the third logical router to an active state to operate in place of the second logical router based on the third state information.

17. The computing apparatus of claim 10, wherein the program instructions further direct the computing apparatus to:
in the first edge gateway, communicate the second state information associated with the first logical router to the second edge gateway, wherein the second edge gateway includes a fourth logical router in a standby state for the first logical router.

18. A system comprising:
a first edge gateway having a first logical router in an active state and a second logical router in a standby state;
a second edge gateway having a third logical router in an active state;
the first edge gateway configured to:
receive state information associated with the third logical router from the second edge gateway;
identify a failure in association with the second edge gateway;
in response to identifying the failure, change the second logical router to an active state to operate in place of the third logical router based on the state information;
maintain second state information for the first logical router and third state information for the second logical router;
identify that the second edge gateway is available;
in response to identifying that the second edge gateway is available, communicate the third state information to the second edge gateway;
the second edge gateway configured to:
receive the third state information; and
in response to receiving the third state information, set the third logical router to an active state to operate in place of the second logical router based on the third state information.

19. The system of claim 18, wherein the first edge gateway is further configured to:
communicate the second state information associated with the first logical router to the second edge gateway, wherein the second edge gateway includes a fourth logical router in a standby state for the first logical router.

20. The system of claim 18, wherein the state information comprises at least firewall state information.

21. The system of claim 18, wherein identifying the failure in association with the second edge gateway comprises identifying that the second edge gateway is unresponsive to a health check message.
